(19) United States
(12) Patent Application Publication
(10) Pub. No.: US 2009/0182577 A1
(43) Pub. Date: Jul. 16, 2009

(54) AUTOMATED INFORMATION MANAGEMENT PROCESS

(75) Inventors: John R. Squilla, Rochester, NY (US); Joseph P. Divincenzo, Rochester, NY (US); Richard Weil, Pittsford, NY (US)

Correspondence Address: Carestream Health, Inc., 150 Verona Street, Rochester, NY, 14608, US

(73) Assignee: Carestream Health, Inc.

(21) Appl. No.: 12/014,149

(22) Filed: Jan. 15, 2008

(51) Int. Cl. G06Q 50/00; G06Q 10/00

(52) U.S. Cl. 705/2; 705/1

(57) ABSTRACT

A method of automating a healthcare facility workflow process includes creating a rule set governing at least one of a collection phase, an organize phase, and a display phase of the healthcare facility workflow process. The rule set is based on at least one of a plurality of decision factors. The method also includes automatically processing a plurality of content based on the rule set. Automatically processing the plurality of content includes one of collecting the plurality of content from a plurality of heterogeneous content sources, organizing the plurality of content based on a desired content hierarchy, and displaying at least one content of the plurality of content based on the desired content hierarchy.

### FIELD OF THE INVENTION

The present invention relates to an automated healthcare facility workflow process and, in particular, to an automated healthcare facility workflow process utilizing aspects of artificial intelligence.

### BACKGROUND OF THE INVENTION

Many different pieces of medical equipment are utilized in healthcare environments for the display of patient information. Such medical equipment is used by surgeons and other healthcare professionals when performing various medical procedures, and the efficient use of such equipment is essential to providing quality service to patients. Streamlining and/or otherwise improving the efficiency of healthcare environment operations with existing equipment, however, can be difficult for a number of reasons.

An exemplary medical workflow processes may include collecting content from a variety of heterogeneous sources, organizing the content based on the physician's preferences, the type or source of the content, and other factors, and displaying the content in an efficient, user-friendly format. However, existing medical workflow systems are not configured to automate the various steps of the workflow process. Nor are existing systems configured to adapt future display protocols based on changes or preferences “learned” in previous related display protocols.

Accordingly, the disclosed system and method are directed towards overcoming one or more of the problems set forth above.

### SUMMARY OF THE INVENTION

In an exemplary embodiment of the present disclosure, a method of automating a healthcare facility workflow process includes creating a rule set governing at least one of a collection phase, an organize phase, and a display phase of the healthcare facility workflow process. The rule set is based on at least one of a plurality of decision factors. The method further includes automatically processing a plurality of content based on the rule set. Automatically processing the plurality of content includes one of collecting the plurality of content from a plurality of heterogeneous content sources, organizing the plurality of content based on a desired content hierarchy, and displaying at least one content of the plurality of content based on the desired content hierarchy.

In another exemplary embodiment of the present disclosure, a method of automating a healthcare facility workflow process includes creating a rule set governing a collection phase, an organize phase, and a display phase of the healthcare facility workflow process. The rule set is based on at least one of a plurality of decision factors. The method also includes automatically processing a plurality of content based on the rule set. Automatically processing the plurality of content includes collecting the plurality of content from a plurality of heterogeneous content sources, organizing the plurality of content based on at least one of an assigned priority level, a desired surgical sequence, and at least one content-specific functionality, and displaying content-specific functionality upon selecting a displayed content of the plurality of content.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a diagrammatic illustration of a workflow process according to an exemplary embodiment of the present disclosure.

FIG. 2 is a diagrammatic illustration of a content display system according to an exemplary embodiment of the present disclosure.

FIG. 3 is a diagrammatic illustration of a collection phase of the exemplary workflow process shown in FIG. 1.

FIG. 4 is a diagrammatic illustration of an organize phase of the exemplary workflow process shown in FIG. 1.

FIG. 5 is a diagrammatic illustration of a display phase of the exemplary workflow process shown in FIG. 1.

FIG. 6 illustrates a display device according to an exemplary embodiment of the present disclosure.

FIG. 7 illustrates a display device according to another exemplary embodiment of the present disclosure.

FIG. 8 illustrates a display device according to a further exemplary embodiment of the present disclosure.

FIG. 9 is a diagrammatic illustration of an automated healthcare facility workflow process according to an exemplary embodiment of the present disclosure.

### DETAILED DESCRIPTION OF THE INVENTION

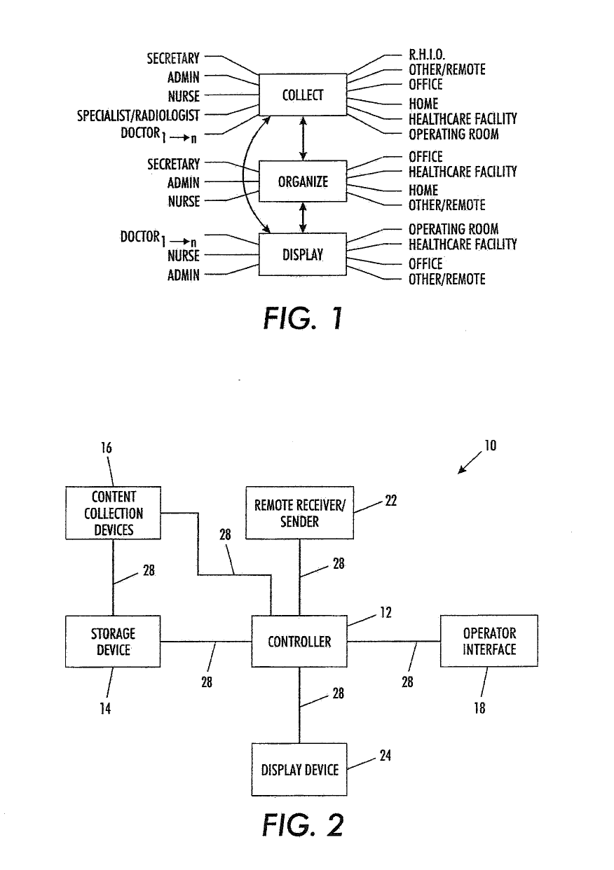

As shown in FIG. 1, a workflow process according to an exemplary embodiment of the present comprises at least a collection phase, an organize phase, and a display phase. During the collection phase, information including but not limited to patient data, medical records, patient photos, videos, medical test results, radiology studies, X-rays, medical consultation reports, patient insurance information, CT scans, and other information related to a medical or surgical procedure to be performed (hereinafter referred to as “content”) can be collected by one or more staff members of a healthcare facility. As shown in FIG. 1, such staff members can include, but are not limited to, secretaries, administrative staff, nurses, radiologist or other specialists, and physicians.

The collected content can originate from a variety of heterogeneous sources such as, for example, different healthcare facilities, different physicians, different medical laboratories, different insurance companies, a variety of picture archiving and communication system (hereinafter referred to as “PACS”) storage devices, and/or different clinical information systems. Likewise, the collected content can be captured in a variety of heterogeneous locations such as, for example, a physician's office, the patient's home, numerous healthcare facilities, a plurality of Regional Health Information Organizations (“RHIOs”), different operating rooms, or other remote locations. As used herein, the term “RHIO” refers to a central storage and/or distribution facility or location in which hospitals and/or other healthcare facilities often share imaging and other content.

In addition, content collected within the operating room can include any kind of content capable of being captured during a surgical procedure such as, for example, live video of a procedure (such as a laparoscopic or other procedure) taken in real-time. Such content can also include X-rays, CR scans, other radiological images, medical images, photographs, and/or medical tests taken during the surgical or medical procedure.

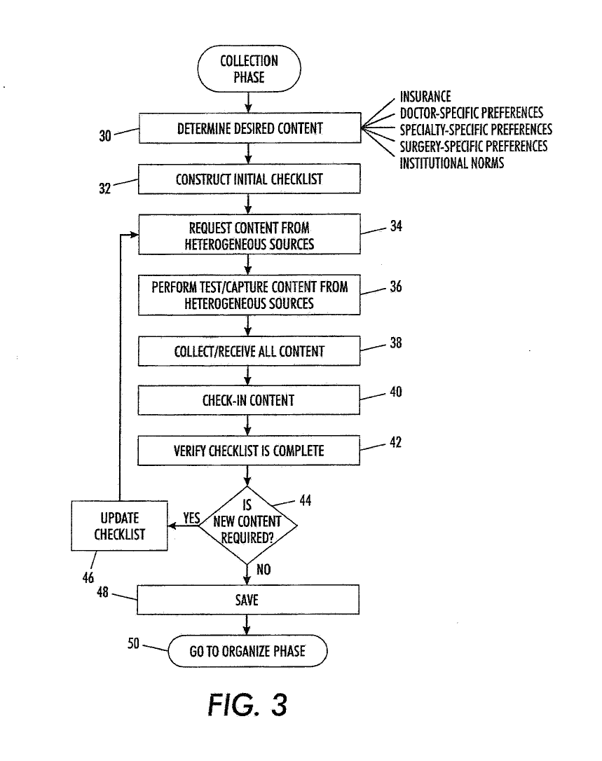

It is understood that content can also be collected during the organize and/or display phases. Such ongoing content collection is schematically represented by the double arrows connecting the organize and display boxes to the collect box in FIG. 1. Each of the heterogeneous content sources and/or locations can embed and/or otherwise associate its own distinct operating and/or viewing system with the item of content collected. For example, during the collection phase, discs containing radiological content can be received from a plurality of healthcare facilities, each configured with its own disparate (e.g., Kodak, Siemens, General Electric, etc.) tools or viewing software. The collection phase will be discussed in greater detail below with respect to FIG. 3.

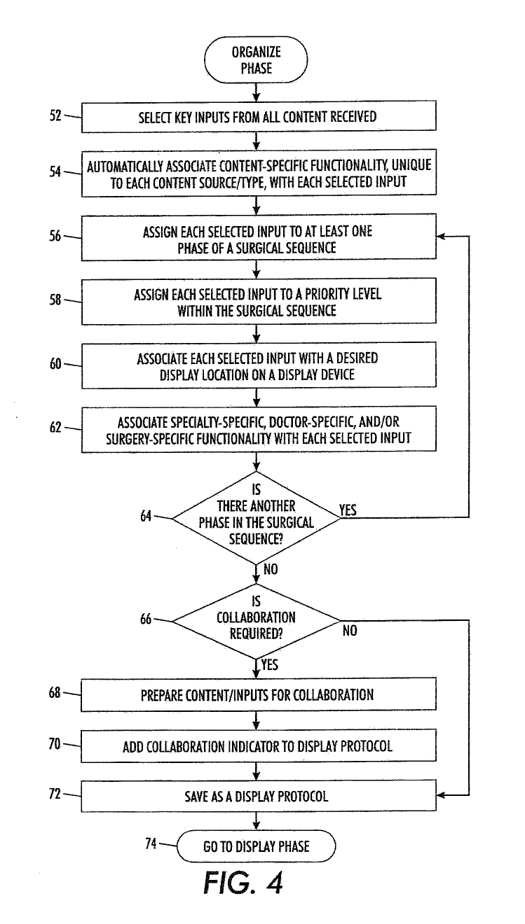

As shown in FIG. 1, during an exemplary organize phase of the present disclosure, a staff member can select key content or inputs from all of the collected content. This selection process can be governed by a variety of factors including, but not limited to, physician-specific preferences, specialty-specific preferences, surgery-specific or medical procedure-preferences, healthcare facility norms/policies, and/or insurance company requirements. As will be discussed in greater detail below with respect to FIG. 4, the organize phase can also include, for example, associating certain functionality with each of the selected inputs, assigning each selected input to at least one phase of a surgical or medical procedure sequence, assigning each selected input to a priority level within the surgical or medical procedure sequence, and associating each selected input with a desired display location on a display device. These and other organize phase tasks can be performed at a hospital or healthcare facility, in a physician's office, at the staff member's home, the doctor's home, and/or in some other remote location.

For example, whereas known systems utilize such content from heterogeneous sources by, for example, printing each item of content and converting it into a form viewable on a patient chart, whiteboard, or light box in an operating room, the exemplary systems and methods of the present disclosure are configured to make the tools and/or viewing software associated with each item of content available for use on a digital display device. For ease of use, the disparate tools and/or viewing software, together with other content-specific, specialty-specific, physician-specific, and/or surgery-specific functionality can be associated with selected content. This functionality can be associated with each item of displayed content as the content is selected for viewing. This is different from known systems which typically utilize a functionality menu containing tools generally applicable to all of the displayed content or only a subset of the content appropriate for that tool. Such known systems can be more complicated to use than the system disclosed herein in that it can be difficult to tell which of the tools in the functionality menu can be appropriately used with a selected item of content. By only providing generalized functionality and not associating content-specific, specialty-specific, physician-specific, and/or surgery-specific functionality with the selected content, the content displayed by such known systems can have limited usefulness and can be difficult to learn to use.

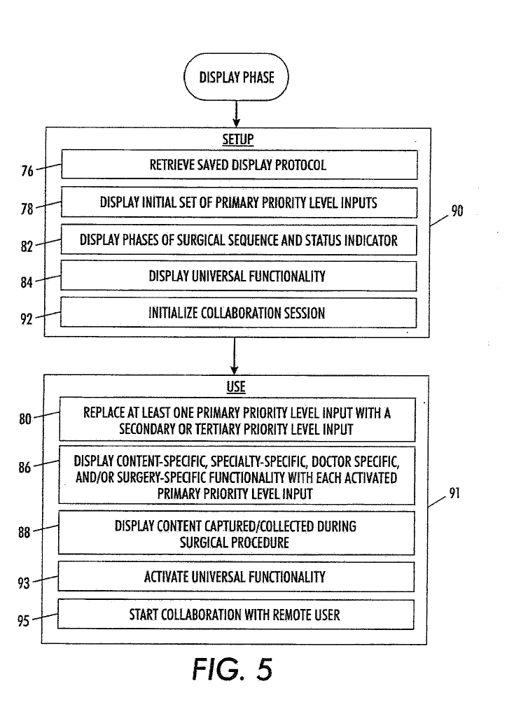

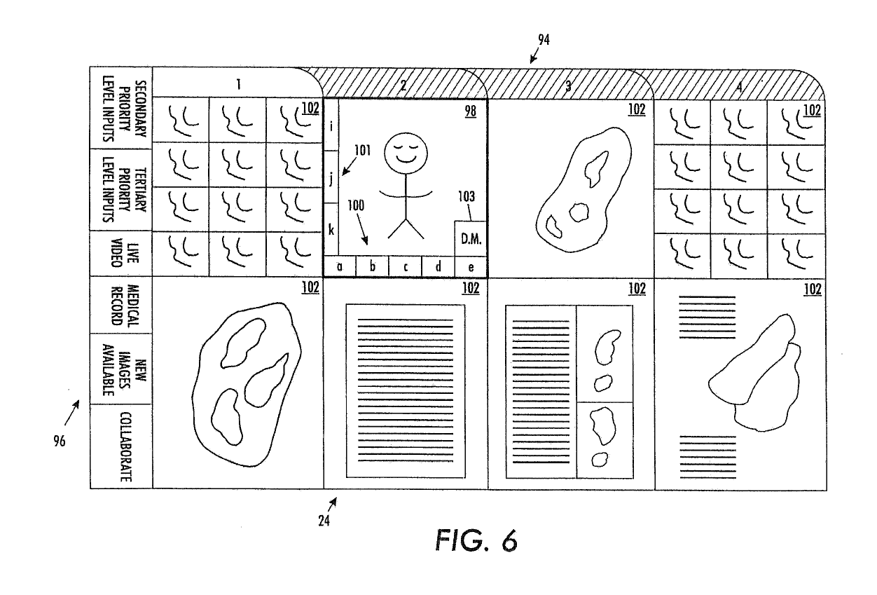

As shown in FIG. 1, during an exemplary display phase of the present disclosure, one or more doctors, nurses, or members of the administrative staff can cause the selected inputs and their associated functionality to be displayed. The content and functionality can be displayed on any conventional display device, and such exemplary devices are illustrated in FIGS. 6, 7, and 8. As will be discussed in greater detail below with respect to FIG. 5, the selected inputs and the functionality associated therewith can be displayed in a variety of locations including, but not limited to, the operating room, other rooms, offices, or locations within a hospital or healthcare facility, the physician's office, and/or other remote locations. It is understood that during the display phase, content captured by and/or collected from any department or organization within the surgeon's office, hospital, or other healthcare facility can also be displayed. As shown in FIG. 1, healthcare facility content can include, for example, a cardio angiogram or other image or series of images taken by a department within the hospital in which the content is displayed.

FIG. 2 illustrates a system 10 according to an exemplary embodiment to the present disclosure. The system 10 of the present disclosure can be modular in that the components of the system 10 can be purchased, sold, and/or otherwise used separately. In addition, the modularity of the system 10 enables the different components to be used at different locations by different users. For example, the modular information management system 10 of the present disclosure can include a collection component, an organization component, and a display component. Each of the separate components of the system 10 can be used in different locations by different users, as illustrated in FIG. 1. Moreover, each of the different components of the modular system 10 can be configured to perform different functions such as, for example, collection, organization, and display.

In an exemplary embodiment, a modular information management system 10 includes a controller 12. The controller 12 can be connected to one or more storage devices 14, one or more content collection devices 16, one or more operator interfaces 18, one or more display devices 24, and/or one or more remote receivers/senders 22 via one or more connection lines 28. It is understood that, in an additional embodiment, the controller 12 can be connected to the remote receiver/sender 22, the one or more operator interfaces 18, the one or more display devices, 24, the one or more storage devices 14 and/or the one or more content collection devices 16 via satellite, telephone, internet, intranet, or wireless means. In such an exemplary embodiment, one or more of the connection lines 28 can be omitted.

The controller 12 can be any type of controller known in the art configured to assist in manipulating and/or otherwise controlling a group of electrical and/or electromechanical devices or components. For example, the controller 12 can include an Electronic Control Unit (“ECU”), a computer, a laptop, and/or any other electrical control device known in the art. The controller 12 can be configured to receive input from and/or direct output to one or more of the operator interfaces 18, and the operator interfaces 18 can comprise, for example, a monitor, a keyboard, a mouse, a touch screen, and/or other devices useful in entering, reading, storing, and/or extracting data from the devices to which the controller 12 is connected. As will be described in greater detail below, the operator interfaces 18 can further comprise one or more hands-free devices. The controller 12 can be configured to execute one or more control algorithms and/or control the devices to which it is connected based on one or more preset programs. The controller 12 can also be configured to store and/or collect content regarding one or more healthcare patients and/or one or more surgical or healthcare procedures in an internal memory.

In an exemplary embodiment, the controller 12 can also be connected to the storage device 14 on which content and/or other patient data is retrievably stored. The storage device 14 can be, for example, an intranet server, an internal or external hard drive, a removable memory device, a compact disc, a DVD, a floppy disc, and/or any other known memory device. The storage device 14 may be configured to store any of the content discussed above. In an embodiment in which the controller 12 comprises an internal memory or storage device, the storage device 14 can supplement the capacity of the controller's internal memory or, alternatively, the storage device 14 can be omitted. In an embodiment where the storage device 14 has been omitted, the content collection devices 16 can be connected directly to the controller 12. In another exemplary embodiment, the storage device 14 can comprise a local server, and a display protocol comprising the content discussed above and the functionality associated with selected inputs can be saved to the server. In still another exemplary embodiment, the storage device 14 can comprise a DVD and the display protocol can be saved to the DVD. In such an embodiment, the display protocol can be fully activated and/or otherwise accessed without connecting the controller 12 to a server.

The connection lines 28 can be any connection means known in the art configured to connect and/or otherwise assist the controller 12 in transmitting data and/or otherwise communicating with the components of the system 10. In an exemplary embodiment, the connection lines 28 can be conventional electrical wires. In an alternative exemplary embodiment, the connection lines 28 can be omitted and as discussed above, the controller 12 can be connected to one or more components of the system 10 via wireless connection means such as, for example, Bluetooth or wireless internet standards and protocols.

The content collection devices 16 can be any device known in the art capable of capturing and/or collecting images, data, and/or other medical content. The content captured and/or collected by the content collection devices 16 can be historical content and/or real-time content. Accordingly, the content collection devices 16 can include capture devices and/or systems such as, for example, ultrasound systems, endoscopy systems, computed tomography systems, magnetic resonance imaging systems, X-ray systems, and vital sign monitoring systems or components thereof. The content collection devices 16 can also include systems or devices configured to retrievably store and/or archive captured content from, for example, medical records, lab testing systems, videos, still images, PACS systems, clinical information systems, film, paper, and other image or record storage media. Such content collection devices 16 can store and/or otherwise retain content pertaining to the patient that is receiving healthcare. This stored content can be transferred from the content collection devices 16 to the storage device 14 and/or the controller 12 during the collection phase discussed above with respect to FIG. 1.

The content collection devices 16 can also capture, collect, and/or retain content pertaining to the surgical procedure that is to be performed on the patient and/or historical data related to past surgical procedures performed on other patients. The content collection devices 16 can store such content in any form such as, for example, written form, electronic form, digital form, audio, video, and/or any other content storage form or format known in the art.

The content collection devices 16 can be used during, for example, inpatient or outpatient surgical procedures, and the content collection devices 16 can produce two-dimensional or three-dimensional “live” or “substantially live” content. It is understood that substantially live content can include content or other data recently acquired, but need not be up-to-the-second content. For example, the content collection devices 16 can capture content a period of time before providing substantially live content to the storage device 14 and/or the controller 12. Delays can be expected due to various factors including content processing bottle necks and/or network traffic. Alternatively, the content collection devices 16 can also include imaging devices that function in a manner similar to, for example, a digital camera or a digital camcorder. In such an exemplary embodiment, the content collection devices 16 can locally store still images and/or videos and can be configured to later upload the substantially live content to the storage device 14 and/or the controller 12. Thus, it is understood that substantially live content can encompass a wide variety of content including content acquired a period of time before uploading to the controller 12. In an exemplary embodiment, the real-time and historical content discussed above can be in a DICOM compliant format. In an additional exemplary embodiment, the real-time and/or historical content can be in a non-DICOM compliant format.

Healthcare professionals are often separated by large distances and can, in some circumstances, be located around the world. Moreover, collaboration between healthcare professionals is often difficult to coordinate due to scheduling conflicts. Accordingly, the remote receiver/sender 22 can be, for example, any display workstation or other device configured to communicate with, for example, a remote server, remote workstation, and/or controller. The remote receiver/sender 22 can be, for example, a computer, an ECU, a laptop, and/or other conventional workstation configured to communicate with, for example, another computer or network located remotely. Alternatively, in an exemplary embodiment, the functions performed, controlled, and/or otherwise executed by the controller 12 and the remote receiver/sender 22 can be performed by the same piece of hardware. The remote receiver/sender 22 can be connected to the controller 12 via satellite, telephone, internet, or intranet. Alternatively, the remote receiver/sender 22 can be connected to a satellite, telephone, the internet, an intranet, or, the controller 12, via a wireless connection. In such an exemplary embodiment, the connection line 28 connecting the remote receiver/sender 22 to the controller 12 can be omitted.

The remote receiver/sender 22 can receive content or other inputs sent from the controller 12 and can be configured to display the received content for use by one or more healthcare professionals remotely. For example, the remote receiver/sender 22 can receive content representative of a computed tomography image, a computed radiography image, and/or X-rays of a patient at the surgical worksite in which the controller 12 is located. A radiologist or other healthcare professional can then examine the content remotely for any objects of interest using the remote receiver/sender 22. In such an exemplary embodiment, the remote receiver/sender 22 is configured to enable collaboration between a remote user and a physician located in, for example, an operating room of a healthcare facility. The remote receiver/sender 22 can also include one or more of the operator interfaces 18 discussed above (not shown). The remote healthcare professional can utilize the operator interfaces of the remote receiver/sender 22 to send content to and receive content from the controller 12, and/or otherwise collaborate with a physician located in the healthcare facility where the system 10 is being used.

The display device 24 can be any display monitor or content display device known in the art such as, for example, a cathode ray tube, a digital monitor, a flat-screen high-definition television, a stereo 3D viewer, and/or other display device. The display device 24 can be capable of displaying historical content and/or substantially real-time content sent from the controller 12. In an exemplary embodiment, the display device 24 can be configured to display a plurality of historical and/or real-time content on a single screen or on a plurality of screens. In addition, the display device 24 can be configured to display substantially real-time content and/or historical content received from the remote receiver/sender 22. Display devices 24 according to exemplary embodiments of the present disclosure are diagrammatically illustrated in FIGS. 6, 7, and 8.

The display device 24 can also display icons and/or other images indicative of content-specific and/or other functionality associated with the displayed content. For example, a user can select one of a plurality of displayed content, and selecting the content may cause icons representative of content-specific, specialty-specific, physician-specific, and/or surgery-specific functionality associated with the selected content to be displayed on the display device 24. Selecting a functionality icon can activate the corresponding functionality and the activated functionality can be used to modify and/or otherwise manipulate the selected content. Such functionality will be discussed with greater detail below and any of the operator interfaces 18 discussed above can be configured to assist the user in, for example, selecting one or more of the displayed content, selecting a functionality icon to activate functionality, and/or otherwise manipulating or modifying the displayed content.

In healthcare environments such as, for example, operating rooms or other surgical worksites, healthcare professionals may desire not to touch certain instruments for fear of contaminating them with, for example, blood or other bodily fluids of the patient. Accordingly, in an exemplary embodiment, the operator interfaces 18 discussed above can include one or more hands-free devices configured to assist in content selection and/or manipulation of content without transmitting bacteria or other contaminants to any components of the system 10. Such devices can include, for example, eye-gaze detection and tracking devices, virtual reality goggles, light wands, voice-command devices, gesture recognition device and/or other known hands-free devices. Alternatively, wireless mice, gyroscopic mice, accelerometer-based mice, and/or other devices could be disposed in a sterile bag or other container configured for use in a sterile surgical environment.

Although not shown in FIG. 2, such operator interfaces 18 can be used by multiple users and can be connected directly to the display device 24 via one or more connection lines 28. Alternatively, the operator interfaces 18 can be wirelessly connected to the display device 24. In still another exemplary embodiment of the present disclosure, the operator interfaces 18 can be connected directly to the controller 12 via one or more connection lines 28 or via wireless means. The operator interfaces 18 discussed above can also be configured to assist one or more users of the system 10 in transmitting content between the controller 12 and one or more remote receivers/senders 22. In an exemplary embodiment in which a plurality of operator interfaces 18 are used by multiple users, a control hierarchy can be defined and associated with the plurality of operator interfaces 18 utilized.

The workflow system 10 of the present disclosure can be used with a variety of other medical equipment in a healthcare environment such as a hospital or clinic. In particular, the system 10 can be used to streamline workflow associated with surgery or other operating room procedures. Ultimately, utilizing the content display system in a healthcare environment will require fewer machines and other medical equipment in the operating room and will result in improved efficiency. In addition, the system 10 can be more user-friendly and easier to use than existing content display systems. As will be described below, the system 10 can be used as a information management system configured to streamline the collection, organization, and display of content in a healthcare environment.

FIG. 3 illustrates a collection phase of a workflow method according to an exemplary embodiment of the present disclosure. In such an exemplary embodiment, the user of the system 10 can determine the content necessary and/or desired for the surgical procedure to be accomplished (Step 30). This determination may be based on a number of factors including, but not limited to, physician-specific preferences, specialty-specific preferences, surgery-specific preferences, the institutional or healthcare facility norms or rules, and insurance company requirements. Once the scope of the desired content has been determined, a staff member can construct an initial checklist (Step 32) stating substantially all of the content the physician would like to have available during the surgical procedure. The initial checklist can include a plurality of heterogeneous content originating from a plurality of heterogeneous sources. Such content and content sources can include any of the heterogeneous content and sources discussed above with respect to FIG. 2. This checklist may be saved for re-use in similar future cases. Alternatively, the checklist can be dynamically reconstructed when necessary for future cases. The user can then request the content on the checklist from the plurality of heterogeneous sources (Step 34) in an effort to complete the checklist. For example, over the years, several radiological studies may have been performed on a subject patient in a variety of different healthcare facilities across the country. The initial checklist may list each of the radiological studies and, in Step 34, a staff member may request these studies from each of the different healthcare facilities in accordance with the preference of the physician. Alternatively, the checklist may contain requests for previous radiology studies that may be relevant for the intended procedure from healthcare facilities or healthcare professionals that have previously treated the patient. Such requests can also include a broadcast request to multiple RHIOs.

Preparing for an upcoming surgical procedure can also require performing one or more tests and/or otherwise capturing content identified on the checklist from a plurality of heterogeneous sources (Step 36). Content listed on the checklist may not have been collected from the subject patient in any prior examinations and must, therefore, be collected by either the staff of the healthcare facility in which the patient is currently visiting or by a different healthcare facility. For example, if a healthcare facility located remotely has a particular specialty, the administrative staff or physician may request that the subject patient visit the alternate healthcare facility to have a test performed and/or additional content captured. Requesting content from heterogeneous sources in Step 34 may also cause the administrative staff to collect and/or otherwise receive any and all of the content listed on the initial checklist (Step 38) and, once received or otherwise collected, the content can be checked in or otherwise marked as collected on the checklist (Step 40).

Once substantially all of the heterogeneous content has been collected, the administrative staff can verify that the initial checklist is complete (Step 42), and if the checklist is not complete, or if any new or additional content is required (Step 44), the administrative staff can update the initial checklist (Step 46) with the additional content. If the initial checklist requires an update, the administrative staff can request the additional content from any of the sources discussed above (Step 34). As discussed above, upon requesting this additional content, the staff can either perform tests or otherwise capture content from the subject patient or can collect content that has been captured from alternative heterogeneous sources (Step 36). The staff may then perform Steps 38-42 as outlined above until the revised checklist is complete. Accordingly, if no new content is required, and the checklist is thus complete, the staff can save all of the collected content (Step 48) and pass to the organize phase of the exemplary process disclosed herein (Step 50). Although Step 50 is illustrated at an end of a collection phase, it is understood that the user can save content at any time during the collection, organization and display phases described herein. In addition, the collection phase illustrated can also include the step of releasing captured and/or collected content to healthcare facilities or other organizations prior to the completion of the initial checklist (not shown).

FIG. 4 illustrates an exemplary organize phase of the present disclosure. As shown in FIG. 4, once all of the content is received in the collection phase, the administrative staff can select each of the key inputs to be used or otherwise displayed from all of the received content (Step 52). It is understood that the key inputs selected can correspond to the items of collected content likely to be utilized by the physician during the upcoming surgical procedure. These key inputs may be selected according to, for example, the specific preferences of the physician, the various factors critical to the surgery being performed, and/or any specialty-specific preferences identified by the physician. Upon selection of the key inputs, the controller 12 and other components of the system 10 may automatically associate content-specific functionality unique to each content source and/or content type with each of the selected key inputs (Step 54). It is understood that, as discussed above, content-specific functionality can be functionality that is associated particularly with the type of content or the source of that content. For example, wherein the selected content is a relatively high resolution image, the content-specific functionality associated with that image may include one or more zoom and/or pan functions. This is because the source of the high resolution image may be a sophisticated imaging device configured to produce output capable of advanced modification. On the other hand, wherein the selected key content is a sequence of relatively low resolution image, such as, for example, a CT scan with 512×512 resolution per slice image, no zoom function may be associated with the content since the source of the low resolution image may not be capable of producing output which supports high-level image manipulation. With such low resolution images, however, a “cine” mode and/or 3D stereo display rendering and functionality may be made available for use if appropriate. Thus the content-specific functionality associated with the selected input in Step 54 may be a function of what the content will support by way of spatial, time manipulation, image processing preferences, display protocols, and other preferences.

The administrative staff may assign each of the selected inputs to at least one phase of a surgical sequence (Step 56). The surgical sequence may be a desired sequence of surgical steps to be performed by the physician and may be a chronological outline of the surgery. In an exemplary embodiment, the surgical sequence may comprise a number of phases, and the phases may include an accessing phase, an operative phase, an evaluation phase, and a withdraw phase. In such an exemplary embodiment, the key inputs related to accessing an area of the patient's anatomy to be operated on, while avoiding collateral damage to surrounding tissue, organs, and/or other anatomical structures, may be assigned to at least the accessing phase, key inputs related to performing an operative step once the anatomy has been accessed may be assigned to at least the operative phase, key inputs related to evaluating the area of anatomy operated upon may be assigned to at least the evaluation phase, and key inputs related to withdrawing from the area of the patient's anatomy and closing any incisions may be assigned to at least the withdrawal phase of the surgical sequence. It is understood that any of the key inputs can be assigned to more than one phase of the surgical sequence and that the surgical sequence organized in Step 56 can include fewer phases or phases in addition to those listed above depending on, for example, the physician's preferences, and the type and complexity of the surgery being performed.

In Step 58, each of the key inputs can be assigned to a priority level within the desired surgical sequence. The priority levels may include a primary priority level, a secondary priority level, and a tertiary priority level, and any number of additional priority levels can also be utilized as desired by the physician. The selected input assigned to the primary priority level can be the inputs desired by the physician to be displayed on the display device 24 as a default. For example, when the system 10 is initialized, each of the primary priority level inputs associated with a first phase of the surgical sequence can be displayed on the display device 24.

By selecting one of the displayed primary priority level inputs, the physician can be given the option of displaying at least one of the corresponding secondary or tertiary priority level inputs associated with the selected primary priority level input. Upon selecting, for example, a corresponding secondary priority level input, the primary priority level input will be replaced by the secondary priority level input and the second priority level input will, thus, be displayed in place of the previously displayed primary priority level input. In an additional exemplary embodiment, the physician can select a secondary or tertiary priority level input first, and drag the selected input over a primary priority level input to be replaced. In such an embodiment, the replaced primary priority level input will be reclassified as and/or otherwise relocated to the secondary priority level where it can be easily retrieved if needed again.

It is understood that the physician can switch between any of the primary, secondary, or tertiary priority level inputs displayed as part of the surgical sequence. It is also understood that a plurality of primary priority level inputs associated with a second phase of the surgical sequence can be displayed while at least one of the inputs associated with the first phase of the surgical sequence is being displayed. In such an exemplary embodiment, it is also understood that the second phase of the surgical sequence can be later in time than the first phase of the surgical sequence. For example, as described above, the surgical sequence can include an accessing phase, an operative phase, an evaluation phase, and a withdrawal phase, and the withdrawal phase may be later in time than the evaluation phase, the evaluation phase may be later in time than the operative phase, and the operative phase may be later in time than the accessing phase. In each of the disclosed embodiments, the layout of the surgical sequence can be modified entirely in accordance the physician's preferences.

The heterogeneous content assigned to the tertiary priority level comprises heterogeneous content that is associated with the selected inputs of at least the primary and secondary priority levels, and the primary, secondary, and tertiary priority levels are organized based upon the known set of physician preferences and/or other factors discussed above. By designating a portion of a study, medical record, or other item of content as a primary priority level or secondary level input, the entire study, medical record, or content item can be automatically selected as a tertiary priority level input. The tertiary priority level inputs can also comprise complete studies, records, or other content unrelated to the selected key inputs but that is still required due to the known set of physician preferences.

Each of the selected inputs can also be associated with a desired display location on the display device 24 (Step 60). It is understood that the step of associating each of the selected inputs with a desired display location (Step 60) can be done prior to and/or in conjunction with assigning each of the selected inputs to at least one of the priority levels discussed above with respect to Step 58. As shown in FIGS. 6, 7, and 8, the display device 24 can illustrate any number of selected inputs 98, 102 desired by the physician.

With continued reference to FIG. 4, specialty-specific, physician-specific, and/or surgery-specific functionality can also be associated with each selected input (Step 62). It is understood that the functionality discussed with respect to Step 62 may be the same and/or different than the content-specific functionality discussed above with respect to Step 54. For example, a zoom function may be associated with a relatively high resolution image, and such functionality may be content-specific functionality with regard to Step 54. However, while a surgical procedure is being performed, the physician may prefer or require one or more linear measurements to be taken on the high resolution image. Accordingly, at Step 62, linear measurement functionality that is physician-specific and/or specialty-specific can be associated with the selected high resolution image. Other such functionality can include, for example, Cobb angle measurement tools, photograph subtraction tools, spine alignment tools, and/or other known digital functionality.

Once Steps 56 through 62 have been completed for each of the selected key inputs in a phase of a surgical sequence, the administrative staff may indicate, according to the known physician preferences, whether or not an additional phase in the surgical sequence is required (Step 64). If another phase in the surgical sequence is required, Steps 56 through 62 can be repeated until no additional phases are required. The administrative staff can also determine whether or not collaboration with a remote user is required (Step 66). If collaboration is required, the system 10 and/or the staff can prepare the content and/or select inputs for the collaboration (Step 68) and, as a result of this preparation, a collaboration indicator can be added to the desired display protocol (Step 70). Once the content has been prepared and the collaboration indicator has been configured, the entire surgical sequence and associated functionality can be saved as a display protocol (Step 72). Alternatively, if no collaboration is required, none of the content will be prepared for collaboration and the surgical sequence and associated functionality can be saved as a display protocol without collaboration (Step 72). Once the display protocol has been saved, the user may proceed to the display phase (Step 74).

As shown in FIG. 5, during the display phase, the user and/or the various components of the system 10 can perform one or more setup functions (Step 90). In an exemplary embodiment, this setup step (Step 90) can include at least the Steps 76, 78, 82, 84, and 92 discussed below. For example, during setup (Step 90), the user can retrieve the saved display protocol (Step 76), and once the system 10 has been activated or initialized, an initial set of primary priority level inputs for the initial surgical phase can be displayed by the display device 24 (Step 78).

The display device 24 can also display surgical sequence phase indicators 94 representing each phase of the surgical sequence and can further display one or more status indicators representing which phase in the surgical sequence is currently being displayed (Step 82). As shown in FIGS. 6, 7, and 8, the surgical sequence phase indicators 94 can be illustrated as one or more folders or tabs (labeled as numerals 1, 2, 3, and 4) outlined in a substantially chronological manner from earliest in time to latest in time. In another exemplary embodiment, the surgical sequence phase indicators 94 can be labeled with user-defined names such as, for example, operation stage names (i.e., “accessing,” “operative,” “evaluation,” and “withdrawal”) or any other applicable sequence nomenclature. It is understood that, in still another exemplary embodiment, the surgical sequence phase indicators 94 can be labeled with and/or otherwise comprise content organization categories. Such categories may link desired content to different stages of the surgery and may be labeled with any applicable name such as, for example, “patient list,” “pre-surgical patient information,” “primary surgical information,” “secondary surgical information,” and “exit.” Accordingly, it is understood that the system 10 described herein can be configured to display content in any desirable way based on the preferences of the user.

The status indicators referred to above may be, for example, shading or other color-coded indicators applied to the surgical sequence phase indicator 94 to indicate the currently active phase of the surgical sequence. The user may toggle between any of the phases of the surgical sequence by activating and/or otherwise selecting the desired surgical sequence phase indicator 94.

As will be discussed below with respect to Step 86, the display device 24 can display a plurality of content-specific, specialty-specific, physician-specific, and/or surgery-specific functionality icons 100 once a particular content 98 has been activated and/or otherwise selected for display. The display device 24 can also display a plurality of universal functionality icons 96 (Step 84) representing functionality applicable to any of the selected or otherwise displayed content regardless of content type or the heterogeneous source of the content. The universal functionality icons 96 may comprise, for example, tools configured to enable collaboration, access images that are captured during a surgical procedure, and/or display complete sections of the medical record.

It is also understood that, as shown in FIGS. 6, 7, and 8, where a collaboration indicator is displayed among the universal functionality icons 96, the user may initialize a collaboration session (Step 92) by selecting or otherwise activating the collaboration indicator. By selecting the collaboration indicator, the user may effectively login to the collaboration session. Such a login can be similar to logging in to, for example, Instant Messenger, Net Meeting, VOIP, Telemedicine, and/or other existing communication or collaboration technologies. It is understood that initializing a collaboration session in Step 92 can also include, for example, determining whether a network connection is accessible and connecting to an available network.

As shown in FIG. 5, during the display phase, the user and/or the various components of the system 10 can also perform one or more use functions (Step 91). In an exemplary embodiment, this use step (Step 91) can include at least the Steps 80, 86, 88, 93, and 95 discussed below. For example, during use (Step 91), selecting one of the displayed primary priority level inputs gives the user access to corresponding secondary and tertiary priority level inputs associated with the selected primary priority level input. By selecting one of the corresponding secondary and tertiary priority level inputs, the user can replace the primary priority level input with the secondary or tertiary priority level input (Step 80). It is understood that one or more of the universal functionality icons 96 discussed above with respect to Step 84 may assist in replacing at least one primary priority level input with a secondary or a tertiary priority level input (Step 80). It is further understood that, in an exemplary embodiment, a primary priority level input that is replaced by a secondary or tertiary level input may always be re-classified as a secondary priority level input, and may not be re-classified as a tertiary priority level input. In such an exemplary embodiment, in the event that new content is received for display, or when a primary priority level input is replaced by a tertiary priority level input, the replaced primary priority level input may be reclassified as a secondary priority level input in Step 80.

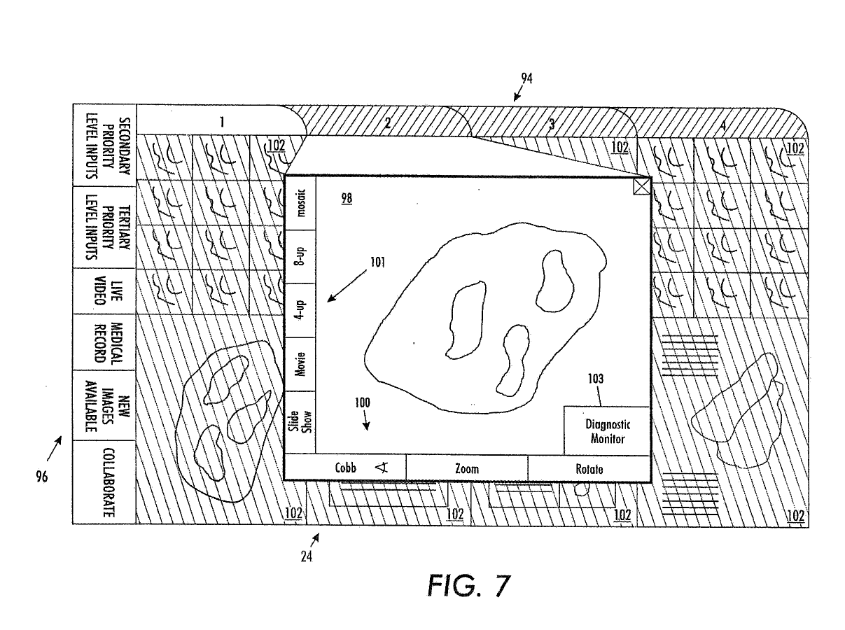

As is also illustrated in FIGS. 6, 7, and 8, the display device 24 can display content-specific, specialty-specific, physician-specific, and/or surgery-specific functionality associated with each activated primary priority level input (Step 86). For example, as illustrated in FIG. 6, in an exemplary embodiment, selecting the content 98 from the plurality of displayed content may cause functionality icons 100 representing the functionality associated with the content 98 to be displayed. In such an exemplary embodiment, functionality icons representing specific functionality associated with content 102 that is displayed, but not selected, may not be displayed. Such functionality icons may not be displayed until the content 102 is selected by the user. This is also illustrated in FIG. 7, wherein the selected input 98 is illustrated in an enlarged view and the functionality icons 100 associated with the content 98 are displayed prominently. The functionality icons 100 can include, for example, icons representing Cobb angle, zoom, rotate, and/or other functionality specifically associated with the activated primary priority level input. The icons 100 can also include, for example, a diagnostic monitor icon 103 configured to send the activated primary priority level input to a secondary diagnostic monitor for display. Such diagnostic monitors can be, for example, high-resolution monitors similar in configuration to the display device 24.

As is also shown in FIGS. 6, 7, and 8, the universal functionality icons 96 applicable to any of the contents 98, 102 displayed by the display device 24 are present at all times. Any of these universal functionality icons 96 can be activated (Step 93) during use.

In an additional exemplary embodiment, selecting the content 98 from the plurality of displayed content may cause functionality icons 101 representing display formatting associated with the content 98 to be displayed. Such display formatting may relate to the different ways in which the selected content can be displayed by the display device 24. As shown in FIG. 7, the display device 24 may be configured to display a selected content 98 in a plurality of formats including, for example, a slide show, a movie, a 4-up display, an 8-up display, a mosaic, and any other display format known in the art. The user may toggle through these different display formats, thereby changing the way in which the manner in which the selected content 98 is displayed, by selecting and/or otherwise activating one or more of the functionality icons 101.

Although not specifically illustrated in FIGS. 6, 7, and 8, it is understood that content can be captured during the collection phase, the organize phase, and/or the display phase, and any of the content captured or collected during either of these three phases can be displayed in substantially real time by the display device 24 (Step 88). Such content can be displayed by, for example, selecting the “new images available” universal functionality icon 96 (FIG. 6).

Moreover, in an exemplary embodiment, initializing the collaboration session in Step 92 may not start collaboration or communication between the user and a remote user. Instead, in such an embodiment, collaboration can be started at a later time such as, for example, during the surgical procedure. Collaboration with a remote user can be started (Step 95) by activating or otherwise selecting, for example, a “collaborate” icon displayed among the universal functionality icons 96, and the collaboration functionality employed by the system 10 may enable the user to transmit content to, request content from, and/or receive content from a remote receiver/sender once collaboration has been started.

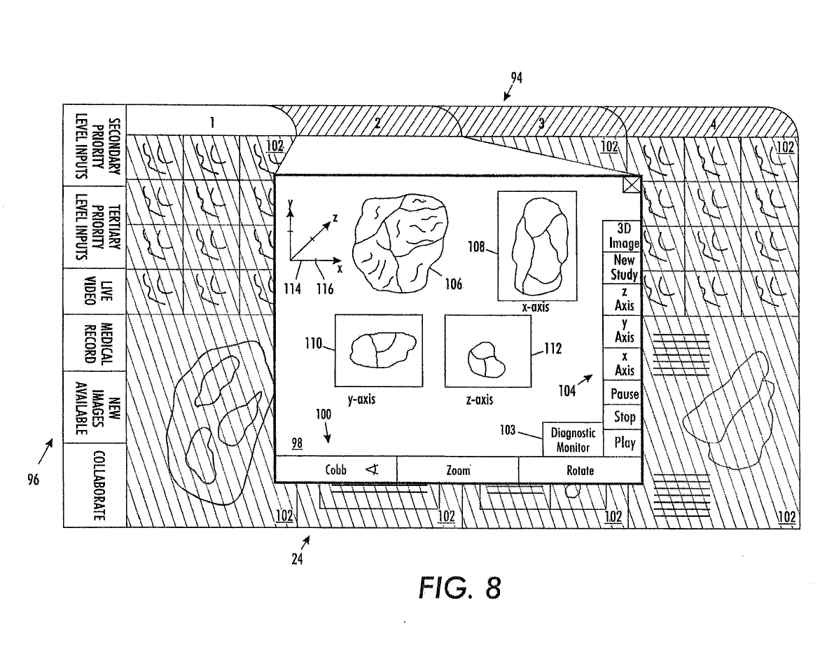

In an additional exemplary embodiment, the display device 24 can be configured to display content comprising two or more studies at the same time and in the same pane. For example, as shown in FIG. 8, the selected content 98 can comprise an image 106 that is either two or three dimensional. The image can be, for example, a three-dimensional rendering of an anatomical structure such as, a lesion, tumor, growth, lung, heart, and/or any other structure associated with a surgical procedure for which the system 10 is being used. The content 98 can further comprise studies 108, 110, 112 done on the anatomical structure. In an exemplary embodiment, the studies 108, 110, 112 can comprise two-dimensional slices/images of the anatomical structure taken in different planes. For example, as shown in FIG. 8, study 108 can be a study comprising a series of consecutive two-dimensional images of the structure wherein the images represent cross-sectional views of the structure in a plane perpendicular to the x-axis in 3D space. Likewise, study 110 can be a study comprising a series of consecutive two-dimensional images of the structure wherein the images represent cross-sectional views of the structure in a plane perpendicular to the y-axis in 3D space, and study 112 can be a study comprising a series of consecutive two-dimensional images of the structure wherein the images represent cross-sectional views of the structure in a plane perpendicular to the z-axis in 3D space. It is understood that the planes represented in the studies 108, 110, 112 can be, for example, the axial, coronal, and saggital planes, and/or any other planes known in the art. In an additional exemplary embodiment, the planes' orientation may be arbitrarily adjusted to provide alignment and viewing perspectives desired by the surgeon. For example, the surgeon may chose to align the y-axis with the axis of a major artery.

To assist the user in viewing these separate studies 108, 110, 112 at the same time, an axis 114 and a location indicator 116 can be displayed with the selected content 98. The axis 114 may illustrate, for example, the axes perpendicular to which the study images are taken, and the location indicator 116 can identify the point along each axis at which the displayed two-dimensional image of the structure was taken. Movement through the studies 108, 110, 112 can be controlled using a plurality of functionality icons 104 associated with the selected content 98. For example, the functionality icons 104 can be used to play, stop, and/or pause movement through the studies 108, 110, 112 simultaneously. Alternatively, the studies 108, 110, 112 can be selected, played, stopped, paused, and/or otherwise manipulated individually by selecting or otherwise activating the functionality icons 104. The icons 104 can also be used to import and/or otherwise display one or more new studies.

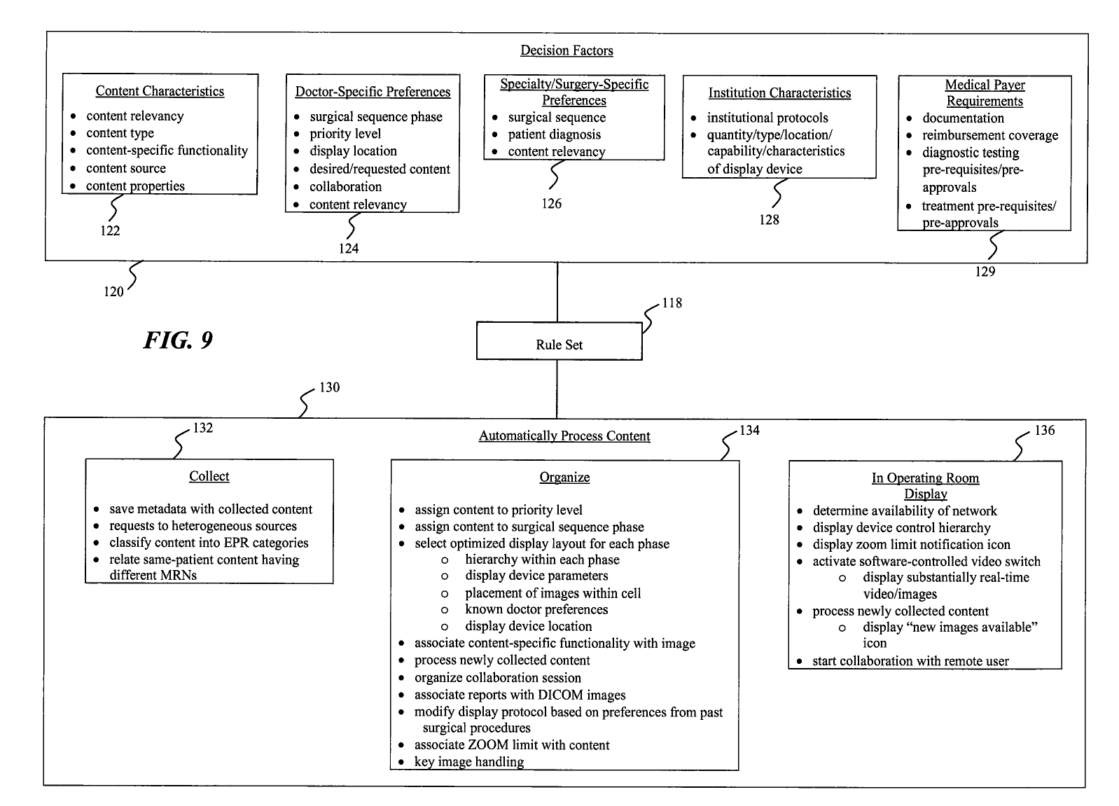

As illustrated in FIG. 9, in an additional exemplary embodiment of the present disclosure, the system 10 described above can be used to automate a healthcare facility workflow process. In such an exemplary embodiment the system 10 can create, for example, a rule set 118 governing at least one of the collection phase, the organize phase, and the display phase discussed above with respect to FIGS. 1-8. The rule set 118 can be based on at least one of a plurality of decision factors 120. Such decision factors 120 can include, for example, content characteristics 122, doctor-specific preferences 124, specialty/surgery-specific preferences 126, institution characteristics 128, and/or payer (e.g., medical insurance company) requirements 129. An exemplary automated healthcare facility workflow process can also include, for example, automatically processing a plurality of content based on the rule set 118. As shown in FIG. 9, automatically processing the plurality of content (Step 130) can include, for example, collecting the plurality of content from a plurality of heterogeneous content sources (Step 132), organizing the plurality of content based on a desired content hierarchy (Step 134), and/or displaying at least one content of the plurality of content based on the desired content hierarchy (Step 136). It is understood that, while portions of the present disclosure describe aspects of the automated healthcare facility workflow process in the context of one or more surgical procedures, such workflow processes can also be used in medical and/or clinical procedures not involving surgery. Such non-surgical procedures can be used in and/or otherwise associated with medical specialties such as, for example, radiation oncology, diagnosis, laser therapy, gastrointestinal, ear nose and throat, dermatology, opthalmology, and cardiology.

The exemplary method of automating a healthcare facility workflow process illustrated in FIG. 9 can be practiced using a number of known techniques. For example, a method of automating a healthcare facility workflow process can incorporate aspects of artificial intelligence to assist in, for example, collecting, organizing, and/or displaying a plurality of content. In such an exemplary embodiment, the use of artificial intelligence can include using previously collected information, known doctor preferences, known specialty-specific and/or surgery-specific preferences, display device characteristics, payer (e.g., medical insurance company) requirements, content characteristics, and/or other information to guide the collection (Step 132), organize (Step 134), and/or display (Step 136) phases of the automated process. For example, a known set of preferences can be used to govern the various phases of an initial healthcare facility workflow process and additional and/or changed preferences, learned from the initial management process, can then be used to govern a future related healthcare facility workflow process.

Utilizing artificial intelligence in the automated healthcare facility workflow process illustrated in FIG. 9 can also include utilizing one or more known experience sets preprogrammed by the user or the administrative staff of the healthcare facility. These experience sets can include, for example, any of the known preferences discussed above. The use of artificial intelligence to assist in automating the healthcare facility workflow process illustrated in FIG. 9 can also include utilizing a set of known preference files stored in, for example, a memory of the controller 12 (FIG. 2). Such preference files can be software preference files and can include, for example, specialty-specific, doctor-specific, surgery-specific, and/or any other preferences discussed above. These preferences can be manually entered, manually changed, imported from an external database (such as a payer database), and/or learned as changes are made by the user throughout the workflow path.

In an additional exemplary embodiment of the present disclosure, automating a healthcare facility workflow process can include utilizing one or more layout designs or templates for guiding and/or otherwise governing the display of content (Step 136). Such layout designs or templates can be predetermined display designs configured to optimize the display of content on a display device 24 (FIG. 2). As illustrated in, for example, FIGS. 6-8, such layout designs or templates can organize the content 98, 102 to be displayed in a format utilizing at least one cell of the display device 24 and, as shown in FIG. 6, the display device 24 can be configured to illustrate at least eight cells worth of content 98, 102. It is understood that the layout designs or templates of the present disclosure can be modified and/or otherwise optimized based on, for example, the capability and/or characteristics of the display device(s) 24, and one or more characteristics of the content being displayed. Such modification and/or optimization of the layout designs will be further discussed below with respect to Step 134.

To assist in automating the healthcare facility workflow processes described herein, metadata can be utilized and/or otherwise associated with any of the content that is collected (Step 132). As will be discussed in greater detail below with respect to Step 132, any desirable metadata associated with the content can be linked to and/or otherwise associated with the content once the content is saved, and the process of associating metadata with the content can be automated in an exemplary embodiment of the present disclosure. For example, metadata associated with electronic patient records (“EPR”) can be linked and/or otherwise associated with the content once the content is scanned or otherwise saved in a memory of the controller 12 or the storage device 14 (FIG. 2). Such metadata can be used when collecting the plurality of content (Step 132) and/or organizing the plurality of content (Step 134). Such metadata can include, for example, the date and time an image was captured, video information (i.e., how long a video is and/or the source of the video, etc.), links to the internet and/or an enterprise network, DICOM image information, and patient identification information (i.e., name, date of birth, address, place of birth, insurance/payer ID number, and/or National Health ID number). It is understood that such metadata can be inputted into the system 10 in a variety of ways such as, for example, keying or manually entering the information using one or more of the operator interfaces 18 discussed above (FIG. 2). Metadata can also be entered using automated metadata entering means such as, for example, bar code scanners or other means known in the art. The metadata can be used to assist in forming linkages between the components or phases of the system 10 discussed above. Stored metadata can assist in the use of content in one or more of the Steps 132, 134, 136 as discussed above. For example, metadata can be used to identify any of the content stored within the system 10 and such metadata can be used to assist in automatically organizing the content with which the metadata is associated.

As discussed above, the rule set 118 governing at least one of the collection phase (FIG. 3), organize phase (FIG. 4), and display phase (FIG. 5) of an exemplary healthcare facility workflow process can be based on at least one of many decision factors 120. Of these decision factors 120, content characteristics 122 can include, for example, a specialist-indicated relevancy determination. In such an exemplary embodiment, a specialist, such as a radiologist, can evaluate one or more large radiological studies and can determine from those studies a grouping of key useful images to be utilized by the physician during, for example, a surgical procedure. This relevancy determination can be utilized as a factor in creating the rule set 118.

As shown in FIG. 9, other content characteristics 122 relevant in creating the rule set 118 can include the type of content, any content-specific functionality associated with the content, the source of the content, and/or the physical properties of the content. The content type can be a decision factor utilized in forming the rule set 118 wherein there is a known content-type preference associated with a user of the system 10 and the collected content is of the preferred type. For example, a physician may prefer utilizing still images of a patient during a surgical procedure as opposed to utilizing real-time video images. In such an example, still images of the patient requiring care can be automatically selected for use during the surgical procedure. Similarly, content-specific functionality can be utilized in forming the rule set 118 wherein there is a known preference for content having any of the content-specific functionality discussed above with respect to, for example, FIG. 4. The fact that the content originates from a particular noteworthy/accurate/reliable content source can also be a decision factor 120 utilized in forming the rule set 118 illustrated in FIG. 9.

In addition, the physical properties of the content can be decision factors 120 utilized in forming the rule set 118. Such properties can include, for example, the inherent image/scanning resolution (i.e., the absolute size of the image and the number of pixels per inch), whether the content is in a color, grayscale, bi-tonal, raw data or formats, the number of bits per pixel, the number of pages included, and other features known in the art.

The decision factors 120 discussed herein can also include doctor-specific preferences 124 comprising, for example, the organization of the surgical sequence phases discussed above with respect to Step 56, the assignment of the priority levels discussed above with respect to Step 58, the desired display location of the content on the display device 24 discussed above with respect to Step 60, and the coordination of the collaboration sessions discussed above with respect to Steps 66, 68, and 95. The doctor-specific preferences 124 can also include, for example, any content that is specifically desired or requested by the physician performing the surgical procedure. It is understood that the physician performing the surgical procedure may also perform his own relevancy determination on any and all of the content collected, and the relevancy determination made by the physician can differ from the relevancy determination discussed above with respect to the content characteristics 122 associated with, for example, a specialist. Accordingly, a content relevancy determination made by the physician can also be a decision factor 120 utilized in the creation of the rule set 118.

As is also illustrated in FIG. 9, specialty/surgery-specific preferences 126 and/or institution characteristics 128 can be decision factors 120 utilized in creating the rule set 118. The preferences 126 can include any of the doctor-specific, specialty-specific, surgery-specific and/or other preferences discussed above with respect to, for example, Step 30. For instance, the specialty/surgery-specific preferences 126 can include organizing the surgical sequence phases discussed above with respect to Step 56 based on factors unique to the physician's specialty or to the particular surgical procedure. The preferences 126 can further include one or more decisions made by the physician performing the surgical procedure based on the physician's diagnosis of the patient. In addition, the preferences 126 can include a determination of content relevancy based on the surgery being performed or the specialty to which the surgery relates. For example, a particular content that may not be viewed as relevant by a specialist such as a radiologist, may still be particularly relevant to the surgery being performed or the specialty with which the surgical procedure is associated. Such relevance may be a decision factor 120 utilized in forming the rule set 118.

Moreover, institutional characteristics 128 such as the institutional norms or protocols discussed above with respect to Step 30 can also be decision factors 120 utilized in forming the rule set 118. The number of display devices 24 (FIG. 2), as well as the type, location, capability, characteristics, and/or other configurations of the display device 24 can be decision factors 120 utilized in forming the rule set 118. Such display device characteristics can include, for example, the media (film, paper, electronic analog, electronic digital, etc.) used to display the image, as well as the size and form factor (i.e., aspect ratio) of the display device 24. Such characteristics can also include, for example, the pixel density/resolution, expected and/or desired viewing distance, color and/or grayscale capabilities, the number of bits per pixel of the display device 24, and other display device characteristics known in the art.

It is understood that some sequencing and artificial intelligence knowledge bases may be driven by the type of medical insurance coverage a particular patient has (if any) and the system 10 may be configured to notify and/or alert a physician from performing medical procedures or services that the patient's medical insurance will not provide reimbursement for. For example, if an X-ray of a patient's arm has already been taken, and the system 10 is aware that the patient's insurance provider will not reimburse for additional X-rays taken within a three-week window of the initial X-ray, the system 10 can be configured to notify a physician when ordering the additional X-ray within the three-week window. In this way, payer/insurance requirements can often affect the treatment provided by the physician. Thus, as shown in FIG. 9, a variety of payer and/or medical insurance company requirements 129 can be decision factors that are considered in the formation of rule set 118. Such requirements can include, for example, the documentation required by the payer for each medical procedure being performed, the amount and scope of reimbursement coverage provided by the payer, any diagnostic testing pre-requisites or pre-approvals, and any treatment pre-requisites or pre-approvals. It is understood that the content characteristics 122, doctor-specific preferences 124, specialty/surgery-specific preferences 126, institutional characteristics 128, and payer requirements 129 discussed above with respect to FIG. 9 are merely exemplary, and decision factors 120 in addition to those discussed above can also be utilized in creating the rule set 118.

The rule set 118 can comprise, for example, a list of commands and/or other operational protocols that can be utilized by the controller 12 (FIG. 2) to assist in automating a healthcare facility workflow process of the present disclosure. In an exemplary embodiment, the rule set 118 can comprise any of the control algorithms or other software programs or protocols discussed above. Accordingly, the rule set 118 can comprise, for example, a logic map that is iteratively adaptive. Such a logic map can, for example, utilize information learned, collected, and/or stored from initial and/or previous healthcare facility workflow processes and can utilize such information to modify, and/or improve future related healthcare facility workflow processes. Accordingly, the rule set 118 may be a dynamic set of rules utilized to govern and/or otherwise control the automation of the healthcare facility workflow processes described herein.

In an exemplary embodiment, the rule set 118 discussed above can be utilized to assist in automatically processing a plurality of content (Step 130). As discussed above, automatically processing the content (Step 130) can include, for example, automatically collecting the plurality of content from a plurality of heterogeneous content sources (Step 132). Once the content is collected, the system 10 can automatically associate and save certain desired metadata with the collected content. For example, information such as the time of day, the date, location, patient identification, room identification, and/or other metadata associated with, for example, the surgical procedure being performed, the healthcare facility in which the surgical procedure is performed, and/or the patient on which the healthcare procedure is being performed, can be saved and/or otherwise associated with the collected content as the content is saved and/or otherwise scanned into one or more memory components of the system 10. Such metadata can be automatically saved and/or scanned with the content as a part of the automated healthcare facility workflow process, and the automatic saving of such metadata may be facilitated by the rule set 118. Such metadata can, for example, assist the user or the system 10 in classifying the content and/or otherwise organizing the content (Step 134).

Collecting the plurality of content from the plurality of heterogeneous content sources (Step 132) can also include automatically requesting the plurality of content from the plurality of heterogeneous content sources. In know devices or workflow processes, if a doctor required a particular content, the doctor would typically request that particular content and a member of the administrative staff of the healthcare facility would begin the process of searching for the required content. In the exemplary processes of the current disclosure, on the other hand, the system 10 can be configured to request the required content from the heterogeneous content sources automatically. Such requests may be made via telephone, electronic mail, machine-to-machine communication, and/or other means known in the art. Such automatic requests can be sent by the system 10 disclosed herein to any specified content storage location such as, for example, the RHIOs, healthcare facilities, or other locations discussed above with respect to FIG. 1.

In automating the healthcare facility workflow management process as discussed above with respect to FIG. 9, techniques known in the art can be used to learn preferences and rules. The system 10 may keep track of changes made to preferences and rules, to assist in an automated content request process, after performing multiple workflow processes.

For example, after making a set of initial content requests, the system 10 can learn preferences and rules through examination of successful or unsuccessful content requests. As a result, in future related workflow processes, the system 10 can modify and/or adapt its automatic content requests based on, for example, the learned information from the initial content request. For example, if in the initial content request the system 10 was successful in obtaining the requested content by utilizing a series of email requests and the system 10 was unsuccessful in obtaining content via a series of telephone requests, in a future related workflow process, the system 10 may utilize email requests instead of telephone requests to obtain related content from the same content source. In this way, a later automatic content request can be modified by the system 10 based on a prior automatic content request response received from the content source.

As shown in FIG. 9, collecting the plurality of content (Step 132) can also include automatically classifying each content of the plurality of content into one of a plurality of EPR categories. As discussed above, the system 10 can learn preferences and rules associated with content classification. Such preferences may include, for example, the physician's preference to place multiple copies of a single content, into different EPR categories. Such categories can include, for example, images, reports, videos, and/or pathology information. Based on this learned preference information, the system 10 can, over time, accurately classify the content into the preferred EPR categories automatically.

Collecting the plurality of content (Step 132) can also include utilizing the aspects of artificial intelligence discussed above to assist in associating collected content with the proper patient. Such techniques can be useful in situations where a plurality of content is collected for a particular patient, and at least some of the plurality of content identifies the patient using information that is different, not current, and/or incorrect. For example, heterogeneous content sources may assign a unique, institution-specific, patient ID number or patient medical record number (“MRN”) to each patient. Thus, if a patient has visited more than one healthcare facility for medical treatment, the content collected (Step 132) from the different facilities may identify the patient using different MRNs. In such a situation, the system 10 may be configured to automatically cross-reference different stored non-MRN metadata associated with the patient's identity to establish a probability-based relationship or association between the collected content and the patient. For example, an artificial intelligence scoring criteria can be used to weigh various non-MRN metadata associated with the patient's identification to determine the likelihood that content from different content sources (and, thus, having different MRNs) is, in fact, associated with the patient in question. Such a probability-based relationship may be established by matching, for example, name, date of birth, address, place of birth, patient insurance/payer ID number, and/or National Health ID number metadata associated with the collected content. The system 10 may give the user the option of verifying the automatically established relationship, and the relationship can be automatically stored for use in categorizing additional content that may be collected for the patient.

Automatically processing the plurality of content (Step 130) can also include organizing the plurality of content based on a desired content hierarchy (Step 134). As shown in FIG. 9, organizing the plurality of content in this way and, thus, automatically processing the plurality of content (Step 130), can include, for example, automatically assigning each content of the plurality of content to one of a primary, a secondary, and a tertiary priority level as discussed above with respect to Step 58. Organizing the plurality of content based on the desired content hierarchy (Step 134) can also include automatically assigning each content of the plurality of content to at least one phase of a surgical sequence as described above with respect to Step 56. Organizing the content (Step 134) can also include automatically selecting an optimized display layout for each phase of a surgical sequence. In an exemplary embodiment, the plurality of content can be saved within the memory components of the system 10, and the system 10 can automatically organize the content for viewing within each phase of a surgical sequence based on the viewing space available on the display device 24. Optimizing the space available may include, for example, automatically selecting an amount of space to be shown between each of the displayed image and having this selection be modifiable based on a particular physician's preferences, automatically selecting a predetermined layout design from a group of saved, or otherwise stored, layout designs. Such layout designs may be configured to utilize the maximum possible viewing area on the display device 24 and, in particular, may be configured to display the content associated with each particular phase in what has been predetermined to be the most ergonomic and/or user friendly manner based on factors such as, for example, the quantity of content associated with the particular surgical phase, the type of content being displayed, the resolution of the content, the size and/or capabilities of the display device 24, institutional characteristics 128, and/or other content viewing factors.

In an exemplary embodiment, selecting an optimized displayed layout for each phase can include, for example, establishing a display hierarchy within each phase of a surgical sequence. In such an exemplary embodiment, automatically selecting the display layout can include automatically assigning each content of the plurality of content to one of the primary, secondary, or tertiary priority levels discussed above with respect to Step 58. Once the content has been associated with a corresponding priority level, for example, each content of the primary priority level can be assigned to one of a preferred priority level and a common priority level within the primary priority level. Once such a hierarchy has been established within the primary priority level, the system 10 can automatically select an optimized display layout wherein the system 10 can automatically display a larger image of the content assigned to the preferred priority level than of the content assigned to the common priority level. It is understood that such a hierarchy can apply to any kind of content such as, for example, live video, still images, and/or other content types. It is also understood that in such an exemplary embodiment, content assigned to the common priority level can be swapped and/or otherwise easily replaced with content assigned to the preferred priority level. In such an exemplary embodiment, at least one of the content assigned to the preferred priority level can be reassigned to the common priority level and, at least one additional content assigned to the common priority level can be reassigned to the preferred priority level. In this way, the automated healthcare facility workflow process described herein with respect to Step 134, can be utilized to suggest to the user a preferred/optimized display layout displaying the plurality of content associated with a surgical procedure. It is understood, however, that the preferred/optimized display layout selected by the system 10 at Step 134 is not mandatory and the user can change the selected optimized display layout at any time based on his/her saved preferences. To update the user's saved preference, the system 10 can utilize known artificial intelligence methods to observe the user's actions, selections, and changes, and the system 10 can be configured to learn new and/or modify existing user preference by observing the user making a decision and/or change that the user has not made previously. It is also understood that the optimized display layout selected for each phase can be determined based on additional factors including, for example, parameters of the display device 24 such as the quantity, type, location, capability, and/or other configurations of the display device 24 discussed above with respect to Step 128. Moreover, selecting an optimized display layout for each phase of a surgical procedure can be further influenced by any of the known doctor-specific, specialty-specific, surgery-specific, and/or other preferences described above.

It is also understood that selecting the optimized display layout for each phase (Step 134) can include optimizing the placement of content images within each cell displayed by the display device 24. In an exemplary embodiment, the images can be placed within each cell based on the initial dimensions of the cell and the overall dimensions of the display device 24. Once all of the content images associated with a particular phase of a surgical sequence have been displayed by the display device 24, optimizing the placement of the images within each cell can include re-optimizing the layout of the entire screen of the display device 24 based on the total number of content images displayed. It is understood that, for example, the size, location, arrangement, and/or other configurations of the content images displayed by the display device 24 can be determined by the system 10 based on a set of known preferences. Accordingly, the content can be initially displayed based on a default set of preferences and the system 10 can automatically reconfigure and/or otherwise optimize the display of such images based on learned information or other known preferences automatically.

Organizing the plurality of content based on a desired content hierarchy in Step 134 can also include automatically determining a desired and/or optimized location for the display device 24 within the operating room. The automatic selection of a display device location within the operating room can be performed as a part of the setup step (Step 90) discussed above with respect to FIG. 5. For example, the system 10 can provide instructions as to where to locate a display device 24 within the operating room based on a known set of doctor-specific preferences and can instruct the administrative staff of the healthcare facility as to where to position one or more display devices 24 within the operating room prior to commencement of the surgical procedure. The system 10 can also provide instructions to the administrative staff regarding the use of multiple display devices 24 situated on booms, tables, rollers, and/or any other known structures utilized for the mounting and/or movement of display devices 24 within an operating room. It is understood that different mounting and/or movement configurations can be utilized with a display device 24 depending on, for example, doctor-specific preferences, surgery-specific requirements, and/or the configuration of the operating room or other institutional protocols or parameters,

As shown in FIG. 9, organizing the plurality of content (Step 134) can also include, for example, automatically associating content-specific functionality with each content of the plurality of content as described above with respect to Step 62. It is understood that the automatic association of functionality can be based on, for example, a known doctor preference and/or other decision factors 120 described above. Organizing the plurality of content in Step 134 can also include, for example, automatically processing newly collected content. In such an exemplary embodiment, the system 10 can automatically classify the newly collected content into one of a plurality of EPR categories and can assign the newly collected content to at least one phase of a surgical sequence as described above with respect to Step 56. In addition, the system 10 can automatically assign the newly collected content to one of a primary, a secondary, and a tertiary priority level as described above with respect to Step 58. In such an exemplary embodiment, the rule set 118, can define how such new content is processed by the system 10. For example, the system 10 can automatically determine whether to display the new content, show the new content with a report associated with the new content, store the new content in a secondary or a tertiary priority level, and/or display images of new content on a full screen of the display device 24. Each of these options, as well as other known options for the display and/or other processing of such new content can be specified as a preference in the rule set 118. As discussed above, aspects of artificial intelligence can be utilized by the system 10 to learn the preferences of the user. For example, the system 10 can request new content processing preferences from each user and can store the preferences for use in further automated healthcare facility workflow processes.

In Step 134, the system 10 can also automatically organize a collaboration session with, for example, a remote specialist and/or other known users. In such an exemplary embodiment, any of the processes discussed above with respect to Step 66, 68, 70, and 95 can be automatically performed by the system 10. For example, the system 10 may store a list of names, telephone numbers, email addresses, and/or other identification information associated with a list of preferred and/or desired collaboration participants. A user such as, for example, a physician, may choose and/or otherwise select who the user wants to collaborate with in a future surgical procedure prior to commencement of the procedure. The system 10 can then automatically send an email, telephone call, and/or other meeting notice to the desired list of collaborators and can also send the desired list of collaborators a link to, for example, a website that the system 10 is connected to. The system 10 can also be configured to automatically capture and/or receive a response from each of the desired collaboration participants and, once the response has been captured, the collaboration can be scheduled in, for example, an electronic calendar of both the physician and each of the desired participants. It is understood that, for example, an email confirming the collaboration session can also be sent to all participants, the physician's secretary, and/or other healthcare facility staff members. In such an exemplary embodiment, the collaboration session can commence once the physician has selected and/or otherwise activated a “collaborate” functionality icon 96 (FIGS. 6-8) displayed on the display device 24.

Organizing the plurality of content based on the desired content hierarchy (Step 134) can also include automatically and/or otherwise associating a physician report with a plurality of DICOM images based on metadata associated with the physician report. It is understood that in an existing healthcare facility workflow processes, written reports can often be dictated and/or otherwise prepared by a physician after reviewing images of a patient. These reports can sometimes be stored and/or otherwise saved as a part of a DICOM image CD that is sent to a requesting physician in preparation for a surgical procedure. However, such reports are often not saved along with the corresponding images on the DICOM image CD. Instead, the written reports are often sent separate from the image CD. In such situations, the system 10 described herein can automatically link written reports received from a content source with their corresponding DICOM image CD. Such automatic linking of the written reports with the corresponding DICOM image CD can be facilitated through the use of metadata that is stored with both the image CD and the written reports once they are received. Such metadata can identify the image CD and the corresponding written report, and can include, for example, patient identification information, date, study and accession number, origination information, the name of the lab and/or healthcare facility from which the DICOM image CD and the written report was sent, and/or any other information that can be useful in linking the DICOM image CD to its corresponding written report in an automated healthcare facility workflow process. Although this automatic linking process has been described above with respect to DICOM image CDs and corresponding written reports, it is understood that the system 10 can be configured to automatically perform such a linking process with any type of collected content.

As shown in FIG. 9, organizing the plurality of content based on a desired hierarchy (Step 134) can also include collecting a plurality of preference information associated with one or more past surgical procedures and automatically modifying an existing or future display protocol based on the plurality of collected preference information. It is understood that the display protocol can be the same display protocol as discussed above in Step 72 with respect to FIG. 4. It is also understood that known artificial intelligence methods or processes can be used by the system 10 to assist in automatically modifying the display protocol. In addition, any of the knowledge basis, software preference files, preset layout designs or templates, automated image sizing algorithms, stored metadata, keyed inputs from healthcare facility administrative staff, linkages between the different phases discussed herein, and/or other information discussed above can also be used to assist in automatically modifying a previously saved display protocol based on newly learned information in related surgical procedures.

Step 134 can further include associating a maximum zoom limit with a content of the plurality of content based on a characteristic of at least one of the content, display device characteristics, and a viewing environment in which the display device 24 is located. Zooming beyond this maximum preset zoom limit can cause one or more notification icons to be displayed by the display device 24. Zooming beyond the maximum zoom limit can also cause one or more sounds, alarms, and/or other indicators to be played and/or otherwise displayed by the system 10. It is understood that the viewing environment can include, for example, the operating room and/or healthcare facility or other institution in which the display device 24 is used. Such characteristics can include, for example, the location of the display device 24 within an operating room, the brightness and/or darkness of the operating room, whether or not other physicians, nurses, or administrative staff members are standing in front of or in the proximity of the display device 24, and/or other known operating room logistical characteristics. Characteristics of the content that may affect the selection of the desired maximum zoom limit can include, for example, the inherent resolution and/or quality of the content being displayed. For example, wherein the content being displayed has a relatively low resolution, zooming in on an image of the content displayed by the display device 24 beyond the desired maximum zoom limit can cause the display device 24 to display a notification icon warning the user that the image displayed is of a degraded quality (Step 136).

As shown in FIG. 9, Step 134 can also include automated handling and/or processing of content that has been designated as “key content” by, for example, a radiologist or other specialist affiliated with the healthcare facility in which the system 10 is being utilized. In an exemplary embodiment, the display device 24 (FIGS. 6-8) can display an icon 96 representing the key images specified by the specialist. During use, the doctor and/or other users of the system 10 can select and/or otherwise activate the key images icon and selecting the icon can provide access to all of the key images substantially instantaneously. For example, selecting the key images icon can cause all of the key images to be displayed by the display device 24 at once. Alternatively, selecting the key images icon can cause one or more of the key images to be displayed by the display device 24 while, at the same time, providing a dedicated “key images menu” linking the user directly to the remainder of the identified key images. Accordingly, the key images icon 96 discussed above can provide the user with rapid access to all of the identified key images regardless of the content previously displayed by the display device 24 or the phase of the surgical sequence currently being executed by the user.

As shown in FIG. 9, automatically processing the plurality of content (Step 130) can also include displaying at least one content of the plurality of content based on the desired content hierarchy discussed above (Step 136). Displaying at least one content of the plurality of content based on the desired content hierarchy can include, for example, automatically determining whether or not a network connection exists between the system 10 and, for example, a server and/or other storage device or component located in the healthcare facility and/or located remotely. If such a network connection does exist, the system 10 can be configured to automatically operate a display protocol saved on the server or other connected memory device. Alternatively, in situations where no such network connections exists, the system 10 can be configured to automatically operate a display protocol that has been saved on, for example, a CD-ROM, a DVD, or other removable memory device in response to this determination. It is understood that the automatic connection to either a network server or a DVD, CD-ROM, or other removable storage device can occur as part of the setup step (Step 90) discussed above with regard to FIG. 5. For example, based on predetermined doctor-specific preferences, the system 10 may be aware that a particular doctor requires and/or prefers a network connection to be present for certain surgical procedures. In such an exemplary embodiment, during setup (Step 90), if the system 10 is not capable of automatically connecting to an existing network, the system 10 can be configured to automatically alert and/or otherwise notify the administrative staff, or other users, that a network connection does not exist or is otherwise unavailable. In response to this determination, the system 10 can be configured to automatically operate a display protocol associated with the surgical procedure to be performed from a back-up DVD or other removable storage device.

As shown in FIG. 9, Step 136 can also include automatically establishing a display device control hierarchy. In such an exemplary embodiment, the doctor, the healthcare facility administrative staff, and/or the system 10 can assign a status level to each user of the system 10. Based on the status level assigned to each user, the system 10 can be configured to automatically determine the display device control hierarchy and privileges allowed for each hierarchy level. Such a hierarchy can be utilized in surgical procedures where more than one operator interfaces 18 (FIG. 2) are being used, or where more than one person is using the system 10 or has access thereto. For example, a single physician and multiple nurses may be present during a surgical procedure and each of those present may utilize one or more operator interfaces 18 during the surgical procedure. For example, the doctor may utilize an operator interface 18 comprising a hands-free control device while each of the nurses may have access to or may otherwise utilize a mouse. In such an exemplary embodiment, a status level may be assigned to each of the users during the setup step (Step 90) discussed above with respect to FIG. 5. Such an exemplary hierarchy may, as a default setting, grant the doctor's operator interface 18 control in situations where the system 10 receives conflicting control commands from the plurality of operator interfaces being utilized. The system 10 can also automatically resolve conflicts between the remainder of the users based on similar status level assignments. Privileges may also vary with the hierarchy level. For example, a remote physician collaborating with the surgeon may be allowed to annotate images on the surgeon's display device 24 but may not be allowed to change the image layout on the surgeon's display device 24.

As discussed above, a maximum zoom limit can be associated with a content of the plurality of content in Step 134. It is understood that zooming beyond the maximum zoom limit can cause a notification icon, alarm, or other indication, to be displayed or sounded by the display device in Step 136. In addition, if the content displayed is not of a high enough resolution and/or is otherwise not capable of being enlarged/magnified through zooming, the zoom functionality icon 100 (FIGS. 7 and 8) discussed above with respect to Step 86 may not be displayed. The various aspects of artificial intelligence discussed above may assist the system 10 in making the determination of whether or not to display such a functionality icon 100.

Displaying at least one content of the plurality of content based on the desired content hierarchy (Step 136) can also include automatically and/or otherwise activating a software-controlled video switch associated with the display device 24. Activating the software-controlled video switch can cause, for example, substantially real-time video and/or other images to be displayed on the display device 24. Such video and/or other images can be displayed in any known manner such as, for example, picture-in-picture, full screen, and an overlay window. In an exemplary embodiment of the automated healthcare facility workflow process discussed herein, the system 10 may be configured to automatically enable the software-controlled video switch as a part of the setup step (Step 90) discussed above with respect to FIG. 5. In such an exemplary embodiment, if the operating room within which the system 10 is utilized, is configured to permit substantially real-time video such as, for example, laparoscopic and/or other surgical videos to be displayed by the display device 24, the system 10 can be configured to automatically make such a determination during Step 90. During the surgical procedure, the doctor and/or other uses of the system 10 can control the display device 24 and/or other components of the system 10 to display the substantially real-time video and/or other images by activating the software-controlled video switch during the surgical procedure. An icon 96 can be displayed by the display device 24 to facilitate the activation of the software-controlled video switch discussed above.

When performing a surgical procedure, even minor delays between, for example, the real-time movement of a surgical tool or instrument by the physician and the image of the moving tool or instrument shown by the display device 24 can be objectionable to the physician. Such a delay is often referred to as “latency.” Thus, in an exemplary embodiment, substantially real-time video and/or other images can be treated as an independent source/input to the system 10 such that latency associated with the display of such content can be minimized and/or otherwise avoided. In such an exemplary embodiment, the substantially real-time video and/or other images may not be integrated into, for example, a video card of the controller 12 (FIG. 2) before the substantially real-time video and/or other images are displayed by the display device 24. Instead, the software-controlled video switch discussed above can be integrated into the controller 12 and/or other components of the system 10. It is understood that such a software level integration of the video switch within the components of the system 10 can assist in substantially reducing the effects of latency. The software-controlled video switch discussed above is merely one example of a device that could be employed by the system 10 to assist in substantially reducing the effects of latency, and it is understood that other like devices could be employed to yield similar results.

Step 136 can also include, for example, automatically processing content that is newly captured and/or collected in, for example, the operating room during a surgical procedure. As discussed above with respect to Step 134, the system 10 can automatically classify the newly collected content into one of a plurality of EPR categories and can assign the newly collected content to at least one phase of a surgical sequence. In addition, the system 10 can automatically assign the newly collected content to one of a primary, a secondary, and a tertiary priority level. For example, during Step 136 the system 10 can automatically determine whether to display the new content, show the new content with a report associated with the new content, store the new content in a secondary or a tertiary priority level, and/or display images of the new content in the operating room. Each of these options, as well as other known options for the display and/or other processing of new content can be specified as a preference in the rule set 118. The display device 24 can also automatically display a “new images available” icon 96 (FIGS. 6-8) to notify the user of the availability of the new content once the new content has been collected and processed in Step 136.

As shown in FIG. 9, Step 136 can also include using aspects of artificial intelligence to start a collaboration session with one or more remote users as described above with respect to Step 95 (FIG. 5). Various known technologies such as, for example, voice over IP, JPEG2000 and/or streaming image viewers, internet-based meeting applications (ex: Microsoft Net Meeting), Image Annotation, and Instant Messaging can be employed by the system 10 to facilitate such a collaboration session.

The exemplary system 10 described above can be useful in operating rooms or other healthcare environments, and can be used by a healthcare professional to assist in streamlining the workflow related to a surgery or medical procedure to be performed, thereby increasing the professional's efficiency during the surgery. For example, the system 10 can automate, among other things, the collection of content, the selection and organization the content, and the display of the content. Thus, during the collect and organize phases, the management of a large volume of content can be taken out of the physician's hands, thereby freeing him/her to focus on patient care.

The automated collection and organization of content can also assist in streamlining hospital workflow by reducing the time it takes to locate pertinent content for display during surgery. Current systems are not capable of such automated data integration.

Moreover, the exemplary system 10 discussed above is fully customizable with specialty-specific, content-specific, physician-specific, and/or surgery-specific functionality, institutional characteristics, and payer requirements. The system 10 can be programmed to automatically perform functions and/or automatically display content in ways useful to the specific type of surgery being performed. Prior systems, on the other hand, require that such specialty-specific and/or activity-specific functions be performed manually, thereby hindering the workflow process.

Other embodiments of the disclosed system 10 will be apparent to those skilled in the art from consideration of this specification. It is intended that the specification and examples be considered as exemplary only, with the true scope of the invention being indicated by the following claims.

### PARTS LIST

10—workflow system
12—controller
14—storage device
16—content collection device
18—operator interface
22—remote receiver/sender
24—display device
28—connection line
30—Step: determined desired content
32—Step: construct initial checklist
34—Step: request content from heterogeneous sources
36—Step: perform test/capture content from heterogeneous sources
38—Step: collect/receive all content
40—Step: check in content
42—Step: verify checklist is complete
44—Step: is new content required?
46—Step: update checklist
48—Step: save
50—Step: go to organized phase
52—Step: select key inputs from all content received
54—Step: automatically associate content-specific functionality, unique to each content source/type, with each selected input
56—Step: assign each selected input to at least one phase or a surgical sequence
58—Step: assign each selected input to a priority level within the surgical sequence
60—Step: associate each selected input with a desired display location on a display device
62—Step: associate specialty-specific, physician-specific, and/or surgery-specific functionality with each selected input
64—Step: is there another phase in the surgical sequence?
66—Step: is collaboration required?
68—Step: prepare content/inputs for collaboration
70—Step: add collaboration indicator to display protocol
72—Step: save as a display protocol
74—Step: go to display phase
76—Step: retrieve saved display protocol
78—Step: display initial set of primary priority level inputs
80—Step: replace at least one primary priority level input with a secondary or tertiary priority level input
82—Step: display phases of surgical sequence and status indicator
84—Step: display universal functionality
86—Step: display content-specific, specialty-specific, physician-specific, and/or surgery-specific functionality with each activated primary priority level input
88—Step: display content captured/collected during surgical procedure
90—Step: setup
91—Step: use phase
92—Step: initialize collaboration
93—Step: activate universal functionality
94—surgical sequence phase indicator
95—Step: start collaboration with a remote user
96—universal functionality icon
98—content
100—functionality icon
101—functionality icon
102—content
103—diagnostic monitor icon
104—functionality icon
106—image
108—study
110—study
112—study
114—axis
116—location indicator
118—rule set
120—decision factors
122—content characteristics
124—doctor-specific preferences
126—specialty/surgery specific preferences
128—institution characteristics
129—medical payer requirements
130—Step: automatically process content
132—Step: collect
134—Step: organize
136—Step: in operating room display

What is claimed is:

1. A method of automating a healthcare facility workflow process, comprising:
a) creating a rule set governing at least one of a collection phase, an organize phase, and a display phase of the healthcare facility workflow process, the rule set being based on at least one of a plurality of decision factors; and
b) automatically processing a plurality of content based on the rule set, wherein automatically processing the plurality of content includes one of
(i) collecting the plurality of content from a plurality of heterogeneous content sources,
(ii) organizing the plurality of content based on a desired content hierarchy, and
(iii) displaying at least one content of the plurality of content based on the desired content hierarchy.

2. The method of claim 1, wherein the plurality of decision factors includes at least one of content characteristics, doctor-specific preferences, institution characteristics, and payer requirements.

3. The method of claim 2, wherein the content characteristics include at least one of a specialist-indicated relevancy determination, a content type, and at least one content-specific functionality.

4. The method of claim 2, wherein the doctor-specific preferences include at least one of a desired phase of a surgical sequence, a desired priority level, and a desired display location.

5. The method of claim 2, wherein the institution characteristics include at least one of an institutional protocol and a display device type.

6. The method of claim 1, wherein automatically processing the plurality of content comprises automatically requesting the plurality of content from a plurality of heterogeneous content sources.

7. The method of claim 6, further including automatically modifying a second automatic content request based on a first automatic request response.

8. The method of claim 1, wherein automatically processing the plurality of content comprises automatically classifying each content of the plurality of content into one of a plurality of electronic patient record categories.

9. The method of claim 1, wherein organizing the plurality of content based on the desired content hierarchy comprises automatically assigning each content of the plurality of content to one of a primary, a secondary, and a tertiary priority level within the desired content hierarchy.

10. The method of claim 1, wherein organizing the plurality of content based on the desired content hierarchy comprises automatically assigning each content of the plurality of content to at least one phase of a surgical sequence within the desired content hierarchy.

11. The method of claim 1, wherein automatically processing the plurality of content comprises automatically selecting a display layout for a phase of a surgical sequence.

12. The method of claim 11, wherein automatically selecting the display layout comprises:
a) automatically assigning each content of the plurality of content to one of a primary, a secondary, and a tertiary priority level,
b) automatically assigning a content of the primary priority level to a preferred priority level within the primary priority level,
c) automatically assigning a content of the primary priority level to a common priority level within the primary priority level, and
d) automatically displaying a larger image of the content assigned to the preferred priority level than of the content assigned to the common priority level.

13. The method of claim 12, further including:
a) assigning the content assigned to the preferred priority level to the common priority level, and
b) assigning the content assigned to the common priority level to the preferred priority level.

14. The method of claim 11, wherein the display layout is selected based on a set of known preferences associated with a physician, the display layout including at least one modification in response to a request from the physician, the request being based on a previous display layout.

15. The method of claim 1, wherein automatically processing the plurality of content comprises automatically associating content-specific functionality with each content of the plurality of content, the at least one decision factor comprising a known doctor preference.

16. The method of claim 1, wherein automatically processing the plurality of content comprises:
a) determining an optimized display layout based on at least one display device parameter, and
b) displaying at least one content of the plurality of content based on the optimized display layout.

17. The method of claim 16, wherein the at least one display device parameter comprises a display device size, a display device quantity, a display device location, or a display device resolution.

18. The method of claim 1, wherein the plurality of content includes a newly collected content and automatically processing the plurality of content comprises:
a) classifying the newly collected content into one of a plurality of electronic patient record categories,
b) assigning the newly collected content to one phase of a surgical sequence, and
c) assigning the newly collected content to one of a primary, a secondary, and a tertiary priority level.

19. The method of claim 1, further including automatically organizing a collaboration session with a remote specialist.

20. The method of claim 1, wherein automatically processing the plurality of content comprises associating a physician report with a plurality images based on metadata associated with the physician report.

21. The method of claim 1, further including automatically determining whether a network connection exists and operating a display protocol saved on a CD-ROM in response to the determination.

22. The method of claim 1, further including assigning a status level to each user of a plurality of users and automatically determining a display device control hierarchy based on at least one of the status level assigned to each user and a privilege level assigned to each user.

23. The method of claim 1, further including activating a software-controlled video switch associated with an operating room display device and displaying substantially real-time video on the display device.

24. The method of claim 1, wherein automatically processing the plurality of content comprises collecting a plurality of preference information associated with past surgical procedures and automatically modifying a display protocol based on the plurality of preference information.

25. The method of claim 1, wherein automatically processing the plurality of content comprises associating a maximum zoom limit with a content of the plurality of content based on a characteristic of at least one of the content, a display device, and a viewing environment, wherein zooming beyond the maximum zoom limit causes a notification icon to be displayed.

26. The method of claim 1, wherein organizing the plurality of content comprises organizing based on at least one of an assigned priority level, a desired surgical sequence, and at least one content-specific functionality.

27. The method of claim 1, wherein displaying at least one content comprises displaying a content-specific functionality icon upon selecting the at least one content.

28. The method of claim 1, wherein collecting the plurality of content comprises automatically classifying a portion of the plurality of collected content into a plurality of electronic patient record categories based a set of known preferences associated with a physician.

29. A method of automating a healthcare facility workflow process, comprising:
a) creating a rule set governing a collection phase, an organize phase, and a display phase of the healthcare facility workflow process, the rule set being based on at least one of a plurality of decision factors; and
b) automatically processing a plurality of content based on the rule set, wherein automatically processing the plurality of content includes
(i) collecting the plurality of content from a plurality of heterogeneous content sources,
(ii) organizing the plurality of content based on at least one of an assigned priority level, a desired surgical sequence, and at least one content-specific functionality, and
(iii) displaying content-specific functionality upon selecting a displayed content of the plurality of content.
